(19) United States
(12) Patent Application Publication
(10) Pub. No.: US 2016/0281511 A1
(43) Pub. Date: Sep. 29, 2016

(54) MODIFIED SURFACE AROUND A HOLE

(71) Applicant: SIEMENS AKTIENGESELLSCHAFT, München (DE)

(72) Inventors: Thomas Hille, TW Eindhoven (NL); Stefan Lampenscherf, Poing (DE)

(73) Assignee: SIEMENS AKTIENGESELLSCHAFT, Munich (DE)

(21) Appl. No.: 14/442,152

(22) PCT Filed: Nov. 5, 2013
(86) PCT No.: PCT/EP2013/073001

§ 371 Date: May 12, 2015

(30) Foreign Application Priority Data
Nov. 16, 2012 (EP) 12192931.9

(51) Int. Cl. F01D 5/18; F01D 25/12; B32B 3/26; F01D 9/02

(52) U.S. Cl. CPC F01D 5/186; F01D 9/02; F01D 25/12; B32B 3/26; F05D 2220/32; F05D 2300/20; B32B 2603/00

(57) ABSTRACT

A layer system is provided having a substrate, an outermost layer with a surface, at least one hole at least in the outermost layer, wherein in the vicinity around the hole or directly adjoining a boundary line of the hole, at least one, not closed extending recess is present in the surface of the outermost layer in which the recess is curved and its ends face each other. Through the use of depressions in a layer, spalling within the interfaces through the layers is prevented.

### CROSS REFERENCE TO RELATED APPLICATIONS

This application is the US National Stage of International Application No. PCT/EP2013/073001 filed Nov. 5, 2013, and claims the benefit thereof. The International Application claims the benefit of European Application No. EP12192931 filed Nov. 16, 2012. All of the applications are incorporated by reference herein in their entirety.

### FIELD OF INVENTION

The invention relates to the modification of a surface around a hole in a layer system.

### BACKGROUND OF INVENTION

Layer systems are used in particular for components operated at high temperatures. These are in particular turbine blades or vanes with a metallic substrate, metallic bonding layer and ceramic thermal barrier layer.

In addition, gas turbine components in particular are cooled by a cooling medium flowing out of a cooling hole in order to cool the component on the inside or else in order to protect the component on the outside against excessively hot gases.

Holes of this type are often made after complete coating of the substrate, in which case the opening can then be a flaw or starting point for crack growth on its inner face.

### SUMMARY OF INVENTION

It is therefore an object of the invention to solve the problem mentioned above.

The object is achieved by one or more recesses around the hole as claimed in the independent claim.

The dependent claims list further advantageous measures which can be combined with one another, as desired, in order to achieve further advantages.

### BRIEF DESCRIPTION OF THE DRAWINGS

FIGS. 1, 2 show a cooling hole according to the prior art,

FIGS. 3-5 show exemplary embodiments of the invention,

FIG. 6 shows a turbine blade or vane,

FIG. 7 shows a combustion chamber,

FIG. 8 shows a list of superalloys.

### DETAILED DESCRIPTION OF INVENTION

The description and the figures represent merely exemplary embodiments of the invention.

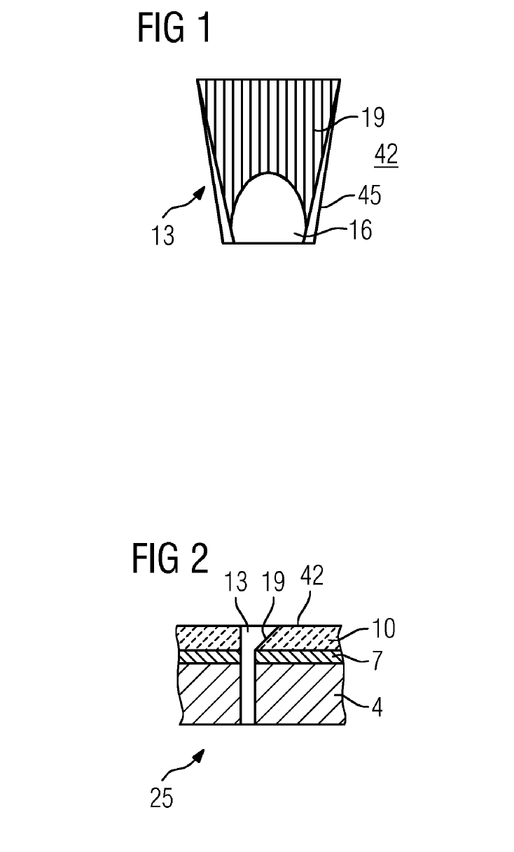

FIG. 1 shows a plan view of a surface 42 of a layer 10 (FIG. 2) having a hole 13, which here in particular is in the form of a film-cooling hole.

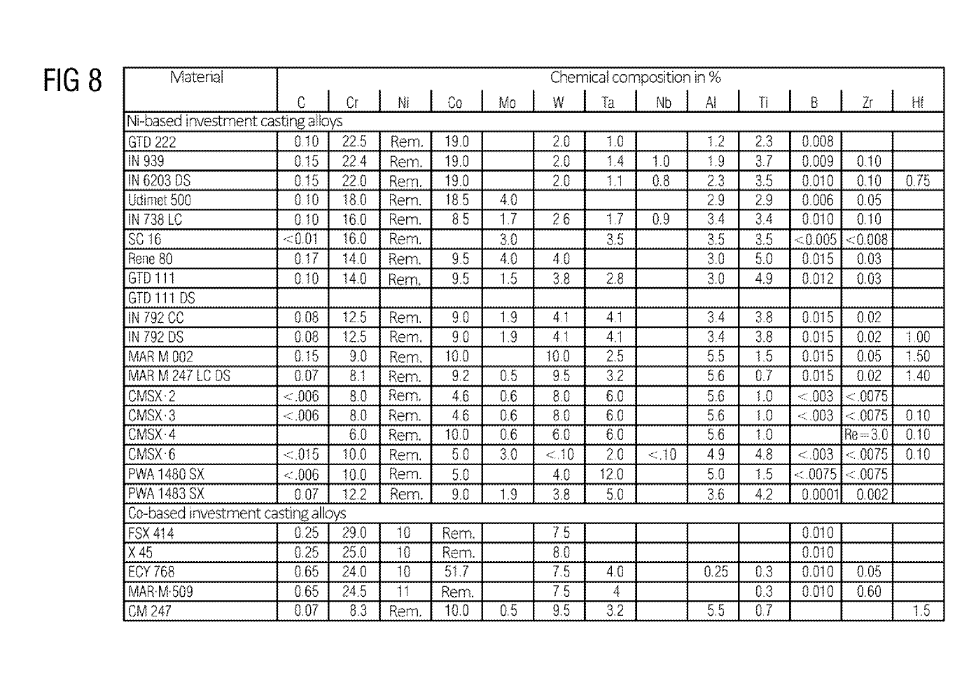

There is a contour 45 around the hole 13 on the surface 42. The film-cooling hole 13 can have a radial bore 16 with a symmetrical or asymmetrical cross section. Depending on the application or location on the combustion chamber brick 155 (FIG. 9) or the turbine blade or vane 120, 130 (FIG. 8), the film-cooling hole 13 is formed with a diffuser 19.

The diffuser 19 constitutes a widening of the bottom portion 16 of the hole 13 (FIG. 2).

FIG. 2 shows a cross section through a layer system 25. The layer system 25 comprises a substrate 4.

The substrate 4 is advantageously metallic and very particularly comprises nickel-based or cobalt-based superalloys.

In this respect, use is advantageously made of alloys as shown in FIG. 8.

An outer ceramic layer 10, which has the outermost surface 42, is applied to the substrate 4 directly or on a metallic bonding layer 7.

A hole 13, which can also have a diffuser 19 on the surface 42, is present continuously through the layer system 25, i.e. through the layers 7, 10 and the substrate 4.

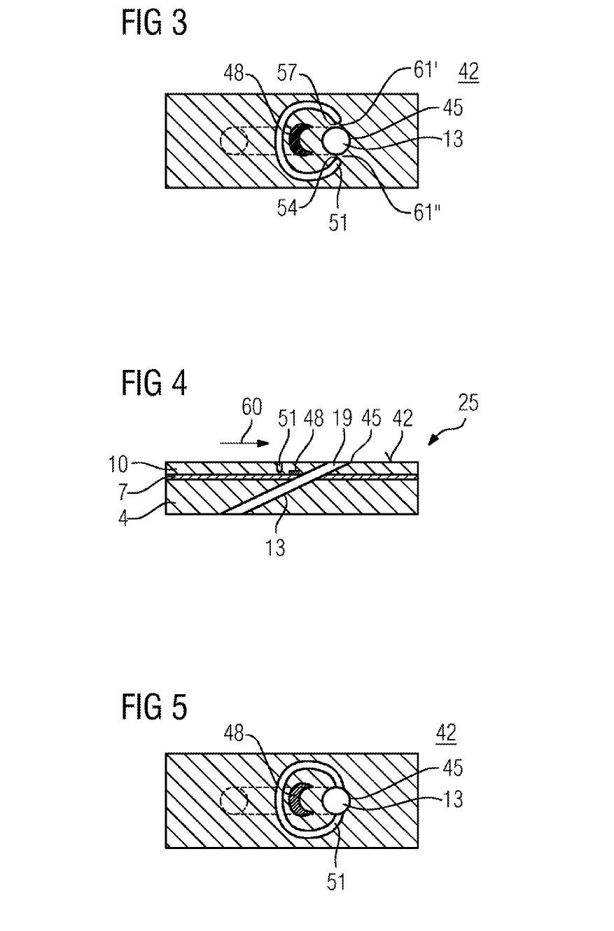

FIG. 3 shows, in plan view, the diffuser 19 or the hole 13. 48 indicates the point in the interface between the ceramic layer and the substrate or the adhesion-promoting layer, whence cracks along the interface can start.

For that reason, there is a curved recess 51 which begins upstream of the hole 13, in an overflow direction 60, and whose ends 54, 57 face each other, in particular approximately centrally at the level of the hole 13 or of the diffuser 19.

The diffuser 19 is not encircled by the recess 51.

The recess 51 is curved, advantageously tong-shaped or O-shaped. As seen in the overflow direction 60, the ends 54, 57 of the recess 51 also represent the end, as seen in the overflow direction 60, of the recess 51.

In this case, the recess 51 is round, oval or curved and can either not touch the hole 13 or the diffuser 19 (FIG. 3) or touch and merge into this hole 13, as is shown in FIG. 5, i.e. the recess 51 is interrupted only by the hole 13 or is at a small distance 60′, 60″ from the opening of the hole 13. In this context, small means <10% of the length of the recess 51.

FIG. 4 shows a cross section through FIG. 2 or, respectively, also through FIG. 5, in which 48 indicates the region of the interface between the ceramic layer and the substrate 4 or adhesion-promoting layer 7, which region begins at the hole 13 and the recess 51 which is located downstream of the region 48 as seen in the flow direction.

The recess 51 thus runs over the hole 13.

In the event of spalling of the TBC 10 proceeding from the cooling air hole 13, the TBC will break off only as far as the recess 51 and a crack will not propagate beyond the recess 51 as seen in the flow direction.

Accordingly, the recess 51 extends largely over the thickness of the outermost layer 10.

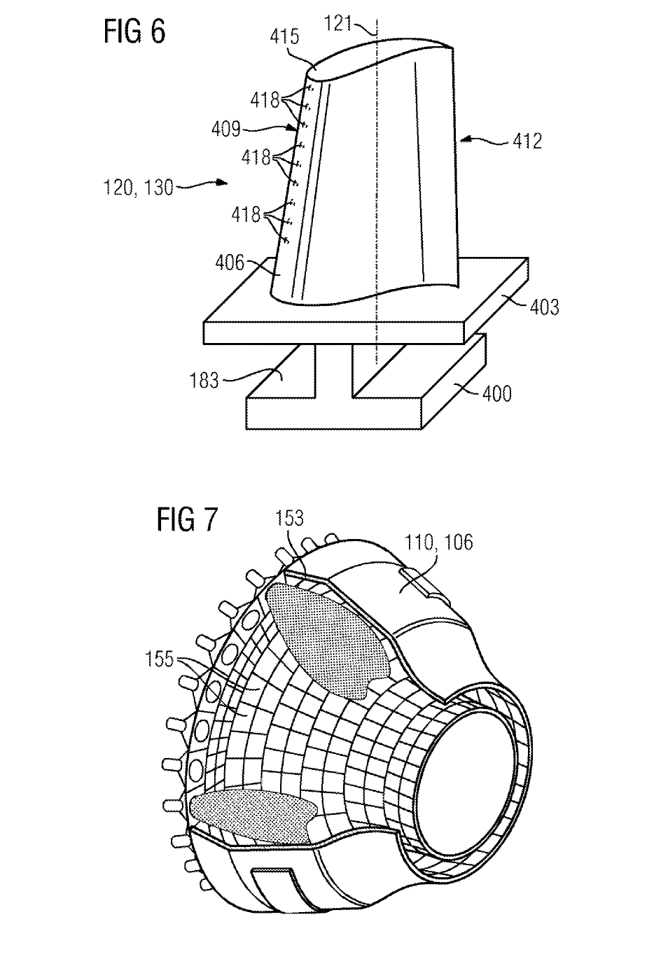

FIG. 6 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is advantageously 95% of the theoretical density.

A protective aluminum oxide layer (TGO=thermally grown oxide layer) is formed on the MCrAlX layer (as an intermediate layer or as the outermost layer).

The layer advantageously has a composition Co-30Ni-28Cr-8Al-0.6Y-0.7Si or Co-28Ni-24Cr-10Al-0.6Y. In addition to these cobalt-based protective coatings, it is also advantageous to use nickel-based protective layers, such as Ni-10Cr-12A1-0.6Y-3Re or Ni-12Co-21Cr-11Al-0.4Y-2Re or Ni-25Co-17Cr-10Al-0.4Y-1.5Re.

It is also possible for a thermal barrier layer, which is advantageously the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier layer covers the entire MCrAlX layer.

Columnar grains are produced in the thermal barrier layer by suitable coating processes, such as for example electron beam physical vapor deposition (EB-PVD).

Other coating processes are possible, for example atmospheric plasma spraying (APS), LPPS, VPS or CVD. The thermal barrier layer may include grains that are porous or have micro-cracks or macro-cracks, in order to improve the resistance to thermal shocks. The thermal barrier layer is therefore advantageously more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

FIG. 9 shows a combustion chamber 110 of a gas turbine.

The combustion chamber 110 is configured, for example, as what is known as an annular combustion chamber, in which a multiplicity of burners 107, which generate flames 156 and are arranged circumferentially around an axis of rotation 102, open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

A for example ceramic thermal barrier layer, consisting for example of ZrO₂, Y₂O₃—ZrO₂, i.e. unstabilized, partially stabilized or fully stabilized by yttrium oxide and/or calcium oxide and/or magnesium oxide, may also be present on the MCrAlX.

Columnar grains are produced in the thermal barrier layer by suitable coating processes, such as for example electron beam physical vapor deposition (EB-PVD).

Other coating processes are conceivable, for example atmospheric plasma spraying (APS), LPPS, VPS or CVD. The thermal barrier layer may include grains that are porous or have micro-cracks or macro-cracks, in order to improve the resistance to thermal shocks.

Refurbishment means that after they have been used, protective layers may have to be removed from heat shield elements 155 (e.g. by sand-blasting).

Then, the corrosion and/or oxidation layers and products are removed. If appropriate, cracks in the heat shield element 155 are also repaired. This is followed by recoating of the heat shield elements 155, after which the heat shield elements 155 can be reused.

A cooling system may also be provided for the heat shield elements 155 and/or their holding elements, on account of the high temperatures in the interior of the combustion chamber 110. The heat shield elements 155 are then for example hollow and may also have cooling holes (not shown) which open out into the combustion chamber space 154.

FIG. 10 shows by way of example a partial longitudinal section through a gas turbine 100.

In its interior, the gas turbine 100 has a rotor 103 which is mounted such that it can rotate about an axis of rotation 102, has a shaft 101, and is also referred to as the turbine rotor.

An intake housing 104, a compressor 105, a for example toroidal combustion chamber 110, in particular an annular combustion chamber, with a plurality of coaxially arranged burners 107, a turbine 108 and the exhaust gas housing 109 follow one another along the rotor 103.

The annular combustion chamber 110 is in communication with a for example annular hot gas duct 111. There, by way of example, four successive turbine stages 112 form the turbine 108.

Each turbine stage 112 is formed for example from two blade or vane rings. As seen in the direction of flow of a working medium 113, a guide vane row 115 is followed in the hot gas duct 111 by a row 125 formed from rotor blades 120.

The guide vanes 130 are secured to an inner housing 138 of a stator 143, whereas the rotor blades 120 of a row 125 are fitted on the rotor 103, for example by means of a turbine disk 133.

A generator (not shown) is coupled to the rotor 103.

While the gas turbine 100 is operating, air 135 is drawn in through the intake housing 104 and compressed by the compressor 105. The compressed air provided at the turbine end of the compressor 105 is passed to the burners 107, where it is mixed with a fuel. The mixture is then burnt in the combustion chamber 110, forming the working medium 113. From there, the working medium 113 flows along the hot gas duct 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they can be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known for example from EP 1 204 776 B1, EP 1 306 454, EP 1 319 729 Al, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 412 397 B1 or EP 1 306 454 A1.

A thermal barrier layer, consisting for example of ZrO₂, Y₂O₃—ZrO₂, i.e. unstabilized, partially stabilized or fully stabilized by yttrium oxide and/or calcium oxide and/or magnesium oxide, may also be present on the MCrAlX.

Columnar grains are produced in the thermal barrier layer by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

1. A layer system at least comprising:
a substrate,
an outermost layer with a surface,
at least one hole at least in the outermost layer,
wherein in the vicinity around the hole or directly adjoining a boundary line of the hole, at least one, not closed extending recess is present in the surface of the outermost layer in which the recess is curved and its ends face each other.

2. The layer system as claimed in claim 1,
wherein the ends of the recess are located centrally at the level of the hole.

3. The layer system as claimed in claim 1,
wherein, as seen in a flow direction, the recess does not enclose, on the surface, the opening of the hole in the downstream region.

4. The layer system as claimed in claim 1,
wherein the recess ends at the boundary line of the hole and merges into the hole.

5. The layer system as claimed in claim 1,
wherein the recess does not end at the boundary line of the hole.

6. The layer system as claimed in claim 1,
wherein the recess extends over at least 70% of the thickness of the outermost layer.

7. The layer system as claimed in claim 1,
wherein which the outermost layer represents a ceramic layer.

8. The layer system as claimed in claim 1,
wherein the hole has a diffuser in the surface, and
wherein the diffuser is not encircled by the recess.

9. The layer system as claimed in claim 1, wherein only one, not closed extending recess is present in the surface of the outermost layer.

10. The layer system as claimed in claim 6, wherein the recess extends over at least 90% of the thickness of the outermost layer.

11. The layer system as claimed in claim 6, wherein the recess is arranged only in the outermost layer.
